(19) United States
(12) Patent Application Publication
(10) Pub. No.: US 2024/0280824 A1
(43) Pub. Date: Aug. 22, 2024

(54) Devices With Adjustable-Tint Lenses

(71) Applicant: Apple Inc., Cupertino, CA (US)

(72) Inventors: Austin S Young, San Mateo, CA (US); Michael J Oudenhoven, San Francisco, CA (US)

(21) Appl. No.: 18/652,620

(22) Filed: May 1, 2024

Related U.S. Application Data
(63) Continuation of application No. PCT/US22/48579, filed on Nov. 1, 2022.
(60) Provisional application No. 63/278,715, filed on Nov. 12, 2021.

(51) Int. Cl. G02B 27/01; G02F 1/1343

(52) U.S. Cl. CPC G02B 27/0172; G02F 1/13439; G02B 2027/0174

(57) ABSTRACT

A head-mounted device may have eyeglass lenses. Each eyeglass lens may have an optical system with inner and outer lens elements and a waveguide and light modulator between the inner and outer lens elements. The waveguide of each system may be configured to receive and guide an image from a projector. The waveguide may have a may have an output coupler configured to direct the image out of the waveguide through the inner lens element to an eye box for viewing by a user. The light modulator in each optical system may be electrically adjustable between a higher transmission state that enhances the visibility of real-world objects through the lens and a lower transmission state that dims ambient light to enhance the visibility of the image from the projector. The light modulator layer may have electrode structures that use portions of the waveguide and/or outer lens element as substrates.

This application is a continuation of international patent application No. PCT/US2022/048579, filed Nov. 1, 2022, which claims priority to U.S. provisional patent application No. 63/278,715, filed Nov. 12, 2021, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have a head-mounted frame in which left and right eyeglass lenses are mounted. Each eyeglass lens may have an optical system with inner and outer lens elements and a waveguide and light modulator between the inner and outer lens elements. The waveguide of each system may be configured to receive and guide an image from a projector. The waveguide may have a may have an output coupler configured to direct the image out of the waveguide through the inner lens element to an eye box for viewing by a user. In addition to viewing projector images in this way, the user may view real-world images through the optical systems by viewing real-world through the inner and outer lens elements, waveguides, and light modulators.

The light modulator in each optical system may be electrically adjustable between a higher transmission state that enhances the visibility of real-world objects through the eyeglass lens and a lower transmission state that dims ambient light to enhance the visibility of the image from the projector. The light modulator layer may have electrode structures that use portions of the waveguide and/or outer lens element as substrates.

### BRIEF DESCRIPTION OF THE DRAWINGS

FIG. 1 is a schematic diagram of an illustrative electronic device such as a head-mounted display device in accordance with an embodiment.

FIG. 2 is a top view of an illustrative head-mounted device in accordance with an embodiment.

FIG. 3 is a top view of an illustrative optical system that includes a waveguide and an optical component such as an adjustable tint layer partly formed using a waveguide cover glass layer in accordance with an embodiment.

FIG. 4 is a top view of an illustrative optical system that includes a waveguide and an optical component such as an adjustable tint layer partly formed using a bias lens as a substrate in accordance with an embodiment.

FIG. 5 is a top view of an illustrative optical system that includes a waveguide and an optical component with curved surfaces in accordance with an embodiment.

### DETAILED DESCRIPTION

Electronic devices such as head-mounted devices may include displays and other components for presenting content to users. A head-mounted device may have head-mounted support structures that allow the head-mounted device to be worn on a user's head. In an illustrative configuration, optical components such as waveguides may be used to provide images from display projectors to eye boxes for viewing by a user while allowing the user to view the real world through the optical components.

The head-mounted devices may have adjustable light modulators (sometimes referred to as adjustable tint layers or adjustable light modulator layers). As an example, a head-mounted device may have an electrically adjustable tint layer that can be used to dynamically attenuate real-world image light in bright environments so that computer-generated images are not overwhelmed and remain visible to a user.

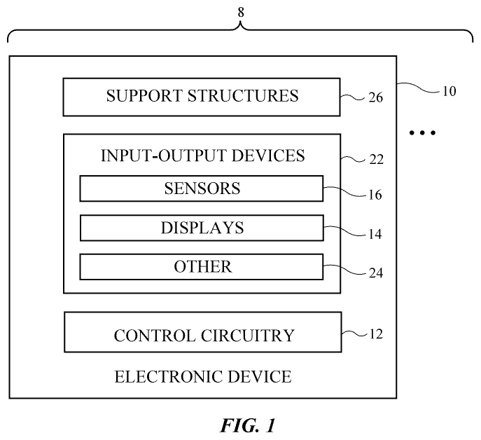

A schematic diagram of an illustrative system that may include a head-mounted device is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device such as a pair of mixed-reality (augmented-reality) glasses are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WIFI® circuitry), millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as displays 14. In some configurations, device 10 includes left and right display devices (e.g., left and right components such as left and right projectors based on scanning mirror display devices, liquid-crystal-on-silicon display devices, digital mirror devices, or other reflective display devices, left and right display panels based on light-emitting diode pixel arrays (e.g., organic light-emitting display panels or display devices based on pixel arrays formed from crystalline semiconductor light-emitting diode dies), liquid crystal display panels, and/or or other left and right display devices that provide images to left and right eye boxes for viewing by the user's left and right eyes, respectively. Illustrative configurations in which device 10 has left and right display devices such as left and right projectors that provide respective left and right images for a user's left and right eyes may sometimes be described herein as an example.

Displays 14 are used to display visual content for a user of device 10. The content that is presented on displays 14 may include virtual objects and other content that is provided to displays 14 by control circuitry 12. This virtual content may sometimes be referred to as computer-generated content. Computer-generated content may be displayed in the absence of real-world content or may be combined with real-world content. For example, an optical coupling system may be used to allow computer-generated content to be optically overlaid on top of a real-world image. In particular, device 10 may have a see-through display system that provides a computer-generated image to a user through a beam splitter, prism, holographic coupler, diffraction grating, or other optical coupler (e.g., an output coupler on a waveguide that is being used to provide computer-generated images to the user) while allowing the user to view real-world objects through the optical coupler and other transparent structures (e.g., transparent waveguide structures, vision-correction lenses and/or other lenses, etc.).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), strain gauge sensors, and/or other sensors.

User input and other information may be gathered using sensors and other input devices in input-output devices 22. If desired, input-output devices 22 may include other devices 24 such as haptic output devices (e.g., vibrating components), light-emitting diodes and other light sources, speakers such as car speakers for producing audio output, circuits for receiving wireless power, circuits for transmitting power wirelessly to other devices, batteries and other energy storage devices (e.g., capacitors), joysticks, buttons, and/or other components.

Electronic device 10 may have housing structures as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, arms or temples in a pair of eyeglasses and/or other structures forming an eyeglasses frame, goggle housing structures, and/or other head-mounted structures). A head-mounted support structure may be configured to be worn on a head of a user during operation of device 10 and may support displays 14, sensors 16, other components 24, other input-output devices 22, and control circuitry 12.

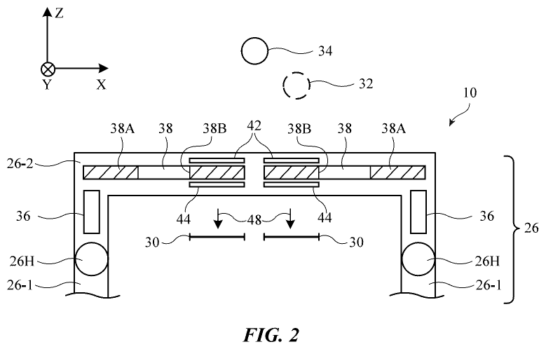

FIG. 2 is a top view of electronic device 10 in an illustrative configuration in which electronic device 10 is a head-mounted device. As shown in FIG. 2, electronic device 10 may include head-mounted support structure 26 to house the components of device 10 and to support device 10 on a user's head. Support structure 26 may include, for example, structures that form housing walls and other structures at the front of device 10 (sometimes referred to as a frame, a lens support frame, a glasses frame, etc.). In particular, support structure 26 may include support structures 26-2 at the front of device 10, which form glasses frame structures such as a nose bridge, a frame portion that supports left and right lenses with embedded waveguides, and/or other housing structures. Support structure 26 may also include additional structures such as straps, glasses side frame structures such as glasses arms (temples), or other supplemental support structures (e.g., support structures 26-1) that help to hold the frame and the components in the frame on a user's face so that the user's eyes are located within eye boxes 30. If desired, support structure 26 may include hinges such as hinges 26H. Support structures 26-1 (which may sometimes be referred to as arms or temples) may be coupled to support structures 26-2 (which may sometimes be referred to as a glasses frame, lens frame, or frame) using hinges 26H (e.g., so that the arms of device 10 can be folded parallel to the frame at the front of device 10 when not in use).

During operation of device 10, images are presented to a user's eyes in eye boxes 30 from projectors 36 using optical systems that include waveguides 38. Waveguides 38 are transparent, so that a user with eyes located in eye boxes 30 may view real-world objects such as objects 34 through waveguides 38 while simultaneously viewing overlaid computer-generated (virtual) images such as virtual image 32.

Eye boxes 30 include a left eye box that receives a left image and a right eye box that receives a right image. Device 10 may include a left display system that presents the left image to the left eye box and a right display system that presents the right image to the right eye box. In an illustrative configuration, each display system has a corresponding projector 36, a waveguide 38, and an optical coupler (e.g., a prism and/or other optical coupling element(s)) to couple an image from the projector into the waveguide from the projector. An output coupler on each waveguide may be used to couple the image out of that waveguide towards a respective eye box after the waveguide has guided the image to a location overlapping the eye box.

In the illustrative configuration of FIG. 2, a left projector 36 may produce a left image and a right projector 36 may produce a right image. Left and right waveguides 38 at the front of device 10 may be provided with left and right optical input couplers 38A that respectively receive the left and right images and couple those images into the left and right waveguides. Waveguides 38 then convey the received images laterally towards the center of device 10 in accordance with the principal of total internal reflection. The left and right images are coupled out of the waveguides towards eye boxes 30 using output couplers 38B (e.g., gratings such as surface relief gratings, holographic output couplers such as holographic output couplers based on volume holograms, or other suitable output couplers).

As shown in FIG. 2, waveguide 38 and output coupler 38B may be mounted in head-mounted support structures 26 between an outer optical element such as outer lens 42 and an inner optical element such as inner lens 44. Lenses 42 and 42 may be formed from glass or polymer. Waveguide 38 may one or more transparent layers of polymer and/or glass and may use output coupler 38B to couple guided display image light out of waveguide 38 towards eye box 30, as shown by display image light 48. Inner lens 44 may have a negative bias component and a user-specific eyeglass prescription component. Outer lens 42 may have a positive bias component that is equal and opposite to that of the negative bias component. As one example, outer lens 42 may have a +1 diopter bias component and inner lens 44 may have a −1 diopter bias component. When viewing real-world images from eye box 30 through the optical systems formed from lenses 42 and 44 and waveguides 38, these two bias components cancel each other. If a user has a vision defect (e.g., nearsightedness or farsightedness), vision correction can be implemented by combining a user's prescription with the negative bias component of inner lens 44. Otherwise, inner lens 44 may include only the negative bias component.

Consider, as an example, a scenario in which a user is nearsighted and has a prescription dictating the use of −0.5 diopter of vision correction. In this situation, the vision correction component of lens 44 will be −0.5. When combined with the −1.0 diopter of the negative bias component, the lens power of inner lens 44 (in this example) will be −1.5 diopter.

Display images that have been coupled into waveguide 38 are coupled out of waveguide 38 towards eye box 30 by output coupler 38B, as shown by display image light 48. The display images pass through the negative bias of inner lens 44, which places the display images at a desired virtual image distance. This virtual image distance is one meter in the illustrative situation where the negative bias of lens 44 is −1 diopter. The vision correction component of lens 44 (which is −0.5 diopter for the illustrative user in the present example) is used to correct for the user's nearsightedness. In general, the vision correction component of lens 44 may be used to correct for farsightedness, nearsightedness, astigmatism, etc.

The presence of a lens power in outer lens 42 that is equal and opposite to the negative bias component of lens 44 compensates for the presence of the negative bias lens power in inner lens 44 when a user is viewing real-world objects. This is because the +1 diopter bias of lens 42 and the −1.0 diopter bias of lens 44 cancel each other so no lens power is imposed on real-world image light that passes through lens 42, waveguide 38, and lens 44 to eye box 30.

The optical systems for the user's left and right eyes (sometimes referred to as eyeglass lenses, optical combiner systems, etc.) may include optical component layers. For example, a fixed light absorbing layer (sometimes referred to as a fixed tint layer) may be formed from a polymer film containing dye and/or pigment (as an example). A tint layer of this type may be mounted on or adjacent to the inner or outer surface of lens 42 (as an example) to help reduce the brightness of real-world objects such as object 34 so that the intensity of real-world image light does not overwhelm the intensity of projector image light from projectors 36 that is used in producing virtual image 32.

If desired, light absorbing layer(s) in device 10 or other optical component(s) may be adjustable. These adjustable optical components may include adjustable layers that are controlled by control signals from control circuitry 12. As an example, an electrically adjustable tint layer (sometimes referred to as an electrically adjustable light modulator or electrically adjustable light modulator layer) may be formed from a guest-host liquid crystal light modulator layer or an organic or inorganic electrochromic light modulator layer. The adjustable tint layer may be formed from structures located between output coupler 38 and lens 42 and/or may be located on the externally facing side of lens 42. During operation of device 10, the electrically adjustable tint layer may be dynamically placed in a high transmission mode when it is desired to enhance the visibility of real-world objects or in a lower transmission mode when it is desired to reduce scene brightness and thereby help enhance the viewability of image light from projectors 36 (e.g., to allow virtual objects such as object 32 to be viewed without being overwhelmed by bright environmental light).

Other electrically adjustable optical components may also be provided for device 10, if desired. These components may include, for example, electrically adjustable polarizer layers such as adjustable polarizers based on liquid crystals, electrically adjustable light reflectors such as adjustable cholesteric liquid crystal layers, electrically adjustable color cast layers such a color cast adjustment layers based on guest-host liquid crystals, adjustable haze layers based on polymer dispersed liquid crystal layers, and/or other electrically adjustable optical layers. In an illustrative configuration, which may sometimes be described herein as an example, the left and right eyeglass lenses of device 10 may be provided with adjustable tint layers (e.g., adjustable light modulator layers such as electrochromic layers, guest-host liquid crystal layers, or other layers configured to exhibit adjustable light transmission). The adjustable tint layers may be used in bright ambient lighting conditions to temporarily decrease the amount of real-world light from objects such as object 34 that reaches eye boxes 30. This reduces scene brightness and thereby allows display image light from waveguide 38 to be viewed at eye boxes 30 without being overwhelmed and thereby washed out by overly bright real-world image light.

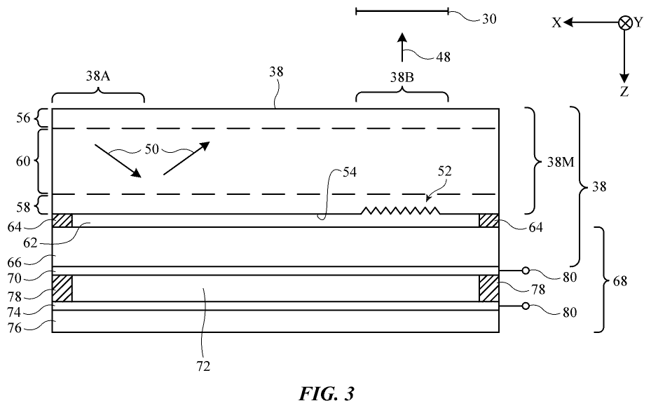

Adjustable tint layers (or other fixed and/or adjustable optical layers) may be attached to the inner and/or outer surfaces of some or all parts of optical components such as lenses 44, lenses 42, and/or waveguides 38. In order to reduce the weight and/or size of device 10, it may be desirable to form adjustable tint components and/or other optical components using transparent substrate structures (transparent layers) that form parts of lenses 42, lenses 44, and/or waveguides 38. Consider, as an example, the illustrative configuration of FIG. 3. In the example of FIG. 3, an adjustable optical component such as an adjustable tint layer has been integrated into waveguide 38. By using some of the structures that form waveguide 38 in forming the adjustable tint layer, the overall size and complexity of the waveguide and tint layer may be reduced.

As shown in FIG. 3, waveguide 38 may include a main waveguide portion 38M (sometimes referred to as a waveguide core layer or waveguide layer). Main waveguide portion (waveguide) 38M may be formed from a layer of glass, polymer, or other transparent material and may guide image light 50 from projector 36. Image light 50 may be received at input coupler 38A of waveguide 38 and guided to output coupler 38B within waveguide 38 in accordance with the principal of total internal reflection. Input coupler 38A may include an external prism, a surface relief grating, a volume hologram, and/or other input coupling structures. Structures such as these may also be used in forming a pupil expander (e.g., a surface-relief-grating pupil expander on the outer surface of portion 38M that expands the image received via input coupler 38A before the image is guided to output coupler 38B).

Output coupler 38B may couple light 50 out of waveguide 38 towards eye box 30 as shown by image light 48. In an illustrative configuration, waveguide portion 38M has an output coupler formed from surface relief grating 52 on inner (inwardly facing) surface 54 of portion 38M. If desired, output coupler 38B may be formed from a hologram. As an example, waveguide portion 38M may have an outer layer 56 (e.g., an outer glass layer, an outer polymer layer, or other transparent outer layer), an inner layer 58 (e.g., an inner glass layer, an inner polymer layer, or other transparent inner layer), and a photosensitive polymer layer 60 that is sandwiched between layers 56 and 58. In this type of arrangement, output coupler 38B may be formed from a volume hologram patterned in polymer layer 60 (and, if desired, a surface relief grating on the outer surface of layer 58 may be used as a pupil expander). Other output coupler arrangements may be used, if desired. Arrangements in which portion 38B is formed from a transparent layer such as a layer of glass or polymer and in which output coupler 38B is formed from grating 52 are described herein as an example.

To ensure that grating 52 (and, if desired, to ensure that a pupil expander formed from a surface relief grating) is not damaged from exposure to dust or other contaminants, grating 52 (and the surface relief grating, if present) may be protected using a hermetically scaled glass layer, polymer layer, or other transparent protective layer such as waveguide cover layer 66. Layer 66, which may be considered to form part of waveguide 38, may be separated from grating 52 and waveguide portion 38M by air gap 62. The peripheral edge of waveguide 38 may have a peripheral adhesive seal such as peripheral seal 64 (e.g., a ring of adhesive that seals air gap 62 from the outside environment). Seal 64 separates portion 38M from layer 66 by air gap 62 while attaching layer 66 to portion 38M.

In addition to serving as part of waveguide 38 and protecting grating 52 of output coupler 38B, layer 66 may serve as a first (innermost) substrate layer in an electrically adjustable optical component such as adjustable tint layer 68. Adjustable tint layer 68 may also have a second (outermost) substrate layer such as layer 76 (e.g., a layer of glass, polymer, or other transparent material). Tint material may be formed in a layer between first layer 66 and second layer 76, as shown by tint layer 72. A peripheral ring of adhesive such as peripheral seal 78 may be used to contain tint layer 72 while spacing layers 66 and 76 apart from each other. Tint layer 72 may be formed from electrochromic material (organic or inorganic materials), guest-host liquid crystal material, and/or other electrically adjustable tint material.

As shown in FIG. 3, adjustable tint layer 68 may have a first and second transparent conductive layers (e.g., layers of indium tin oxide or other transparent conductive coating material) such as first transparent electrode 70 and a second transparent electrode 74. Electrode 70 may be formed as a coating on the outer surface of layer 66 and electrode 74 may be formed as a coating on the corresponding inner surface of layer 76 (as an example). Terminals 80 may receive control voltages from control circuitry 12. By adjusting the voltage across terminals 80, the electric field applied by electrodes 70 and 74 to layer 72 may be adjusted, thereby adjusting the amount of light transmission exhibited by layer 68. In an illustrative configuration, layer 68 may exhibit a variable amount of light transmission ranging continuously between a minimum level of TMIN and a maximum level of TMAX. The value of TMIN may be 5%, 10%, 15%, 20%, 2-15%, 3-25%, 5-40%, 10-30%, 10-25%, at least 3%, at least 6%, at least 15%, at least 20%, less than 35%, less than 25%, less than 15%, or other suitable minimum level sufficient to help reduce environmental (real-world) light during viewing of computer-generated images from projectors 36 in bright environmental lighting conditions. The value of TMAX may be at least 50%, at least 60%, 60-99%, 40-99.9%, 80-99%, 70-99%, 80-97%, at least 70%, at least 80%, at least 85%, at least 90%, at least 95%, less than 99.99%, less than 99%, or other suitable maximum level sufficiently transparent to allow a viewer to comfortably view real world objects through layer 68 during situations where projectors 36 are not supplying images or other situations where higher transmission levels are desirable. When mounted in support structures 26, the waveguide and adjustable tint structures of FIG. 3 may be located between outer lens 42 and inner lens 44 to form a head-mounted device optical system as described in connection with FIG. 2.

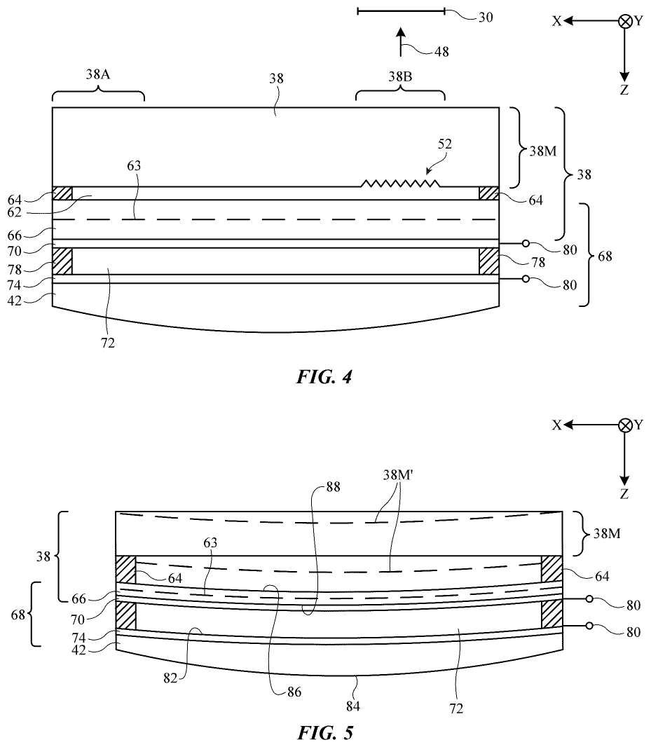

If desired, outer lens 42 may serve as part of an adjustable optical component such as adjustable tint layer 68. This type of arrangement is shown in FIG. 4. As shown in FIG. 4, waveguide 38 may be formed from a glass layer (main portion 38M) patterned on its outer surface to form surface relief grating 52 for output coupler 38B. During operation, image light from projector 36 is received at input coupler 38A (e.g., a prism, grating, hologram, and/or other input coupler structures) and is guided to output coupler 38B, where this image light is directed towards eye box 3 as shown by image light 48. Main portion 38M of waveguide 38 may be separated by cover layer 66 by air gap 62, as described in connection with FIG. 3. Cover layer 66 may serve as a first (innermost) substrate for an adjustable light modulator such as adjustable tint layer 68. Outer lens 42, which is a plano-convex lens in this example, may serve as a second (outermost) substrate for layer 68. Electrodes 70 and 74 may be formed on the outwardly facing and inwardly facing surfaces of layer 66 and lens 42, respectively. Peripheral seal 64 may seal air gap 62 to help protect grating 54 (and/or to protect other grating structures on the outer surface of waveguide portion 38M such as a pupil expander surface relief grating). As described in connection with FIG. 3, portion 38M may, if desired, have an output coupler formed from a photosensitive polymer layer sandwiched between first and second glass layers. The example of FIG. 4, in which portion 38M has a single glass waveguide layer, is illustrative.

As shown in FIG. 4, peripheral seal 78 may help contain tint layer 72 between layer 66 and lens 42. During operation, control circuitry 12 may apply control signals for layer 68 to electrodes 70 and 74 using control terminals 80. Electrical connections to terminals 80 of FIGS. 3 and 4 may be formed using solder, using conductive adhesive, using direct contact with metal pins or other contacts, using through-glass vias filled with conductive material, and/or other electrical contact arrangements.

If desired, the structures of light modulator layer 68 may be separated by an air gap from the structures of waveguide 38. For example, layer 66 may be divided into a first (inner) portion and a second (outer) portion along line 63 and these portions may be separated by an air gap. The first portion of layer 66 in this type of configuration serves as part of waveguide 38 and may be attached to portion 38M with peripheral seal 64. This first portion of layer 66 may serve as a protective cover layer to protect grating 52 (and any other surface relief grating structures on portion 38M such as a pupil expander grating). The second portion of layer 66 in this type of configuration serves as a substrate for electrode 70 in light modulator layer 68, but does not serve as part of waveguide 38. In arrangements such as these in which the structures of waveguide 38 are separated by an air gap from the structures of the tint layer (e.g., when no substrates are shared between the waveguide and tint layer), a fixed tint layer (e.g., a dark polymer film) may be used in place of layer 68 when electrical adjustability for the opacity of layer 68 is not desired.

In the example of FIG. 4, waveguide 38 has a planar shape and the inwardly facing surface of lens 42 on which electrode 74 is formed is planar (e.g., lens 42 of FIG. 4 is a plano-convex lens). If desired, lens 42 may have a curved inwardly facing surface. Other structures device 10 such as one or more glass layers forming a protective waveguide cover layer, one or more waveguide layers forming waveguide portion 38M, lens 44, etc. may also have one or more curved inner and/or outer surfaces.

Consider, as an example, the arrangement of FIG. 5. In the illustrative configuration of FIG. 5, waveguide 38 has main portion 38M and cover layer 66. Main portion 38M may be planar or may have inner and/or outer surfaces that are curved as shown by illustrative curved main portion 38M′. Outer lens 42 may have curved outer surface 84 and curved inner surface 82. Cover layer 66 may have planar and/or curved surfaces (see, e.g., illustrative curved inner surface 86 and curved outer surface 88). Tint material 72 may be formed between lens 42 and layer 66. Air gap 62 may be formed between layer 66 and main portion 38M. With this type of configuration, lens 42 may have curved outer and inner surfaces (e.g., lens 42 may be a meniscus lens). The inner and/or outer surfaces of layer 66 may be planar, may exhibit compound curvature (e.g., these surfaces may be non-developable surfaces that cannot be flattened into a plane without distortion), and/or may be developable surfaces (e.g., surfaces that are bent about a single axis such as the Y axis of FIG. 5 and can therefore be flattened into a plane without distortion). The inner and outer curved surfaces of lens 42 may be characterized by compound curvature (e.g., surface 82 may be concave and surface 84 may be convex). In general, portion 38M, layer 66, and lens 42 may have planar surfaces, developable curved surfaces, and/or non-developable curved surfaces. The example of FIG. 5 in which the inner and outer surfaces of layer 66 have developable and/or non-developable curved surfaces and in which the inner and outer surfaces of lens 42 have non-developable curved surfaces (concave and convex surfaces, respectively) is illustrative. As described in connection with FIG. 4, layer 66 may, if desired, be separated into inner and outer portions with an air gap located along line 63. In this type of arrangement, the inner layer may, if desired, be planar, whereas the outer layer (the inner substrate portion of tint layer 68) may have opposing first and second curved surfaces (as an example).

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

In accordance with an embodiment, a head-mounted device is provided that includes a head-mounted support structure, a projector that is supported in the head-mounted support structure and that is configured to produce an image, a waveguide that is supported in the head-mounted support structure, that has a first transparent layer configured to guide the image to an output coupler that directs the image toward an eye box, and that has a second transparent layer attached to the first transparent layer with a peripheral seal, the first and second transparent layers are separated by an air gap, and an electrically adjustable light modulator that is supported in the head-mounted support structure, that has a third transparent layer, and that has a layer of adjustable tint material between the second transparent layer and the third transparent layer. In accordance with another embodiment, the head-mounted device includes a first transparent conductive electrode on the second transparent layer and a second transparent conductive electrode on the third transparent layer, the first and second transparent conductive electrodes are configured to apply an electric field to the layer of adjustable tint material to control an amount of light transmission associated with the electrically adjustable light modulator.

In accordance with another embodiment, the output coupler includes a grating on a surface of the first transparent layer facing the air gap.

In accordance with another embodiment, the first transparent layer is configured to guide light associated with the image in accordance with the principal of total internal reflection.

In accordance with another embodiment, the head-mounted device includes a peripheral ring of adhesive that attaches the third transparent layer to the second transparent layer.

In accordance with another embodiment, the adjustable tint material includes a guest-host liquid crystal material.

In accordance with another embodiment, the electrically adjustable light modulator includes an electrically adjustable electrochromic light modulator layer.

In accordance with another embodiment, the first transparent layer includes a first glass layer and the second transparent layer includes a second glass layer.

In accordance with another embodiment, the third transparent layer includes a third glass layer.

In accordance with another embodiment, the head-mounted device includes first and second lens elements, the waveguide and the electrically adjustable light modulator are between the first and second lens elements.

In accordance with another embodiment, the first transparent layer includes a first polymer layer and the second transparent layer includes a second polymer layer.

In accordance with another embodiment, the third transparent layer includes a third polymer layer.

In accordance with another embodiment, the head-mounted device includes first and second lens elements, the waveguide and the electrically adjustable light modulator are between the first and second lens elements.

In accordance with another embodiment, the output coupler includes a hologram.

In accordance with another embodiment, the waveguide includes a fourth transparent layer and includes a polymer layer that contains the hologram, the polymer layer is between the first transparent layer and the fourth transparent layer.

In accordance with another embodiment, the third transparent layer is a polymer lens element with a positive lens power.

In accordance with another embodiment, the head-mounted device includes a first lens element, the third transparent layer includes a second lens element and the waveguide is between the first lens element and the second lens element.

In accordance with another embodiment, the electrically adjustable light modulator is configured to exhibit a maximum light transmission value of at least 90%.

In accordance with another embodiment, the electrically adjustable light modulator is configured to exhibit a minimum light transmission value of less than 25%.

In accordance with another embodiment, the third transparent layer has first and second opposing curved surfaces.

In accordance with an embodiment, an optical system for a head-mounted device having a projector that produces an image, the optical system is provided that includes an inner lens element facing an eye box, an outer lens clement, a waveguide that is between the inner lens clement and the outer lens element, the waveguide having an output coupler that directs the image towards the eye box through the inner lens element, and an electrically adjustable light modulator having an adjustable tint layer that is between the waveguide and the outer lens element, the waveguide has a main portion and has a cover layer that is attached to the main portion and is separated from the main portion by an air gap and the electrically adjustable light modulator has a transparent conductive coating on the cover layer.

In accordance with another embodiment, the cover layer includes a cover glass layer, the electrically adjustable light modulator has a glass substrate layer with an additional transparent conductive coating, the adjustable tint layer is between the transparent conductive coating on the cover glass layer and the additional transparent conductive coating on the glass substrate layer, and the glass substrate layer is between the outer lens element and the waveguide.

In accordance with an embodiment, a head-mounted device optical system operable in a head-mounted device with a projector that produces an image is provided that includes a first lens element, a second lens element, a waveguide that is between the first and second lens elements and that is configured to guide the image, the waveguide has a waveguide glass layer with a surface relief grating and has a cover glass layer configured to protect the surface relief grating, the cover glass layer is attached to the waveguide glass layer with adhesive so that the surface relief grating is separated by an air gap from the cover glass layer, and an adjustable light modulator having a transparent conductive electrode on the cover glass layer.

The foregoing is merely illustrative and various modifications can be made to the described embodiments. The foregoing embodiments may be implemented individually or in any combination.

What is claimed is:

1. A head-mounted device, comprising:
a head-mounted support structure;
a projector that is supported in the head-mounted support structure and that is configured to produce an image;
a waveguide that is supported in the head-mounted support structure, that has a first transparent layer configured to guide the image to an output coupler that directs the image toward an eye box, and that has a second transparent layer attached to the first transparent layer with a peripheral seal, wherein the first and second transparent layers are separated by an air gap; and
an electrically adjustable light modulator that is supported in the head-mounted support structure, that has a third transparent layer, and that has a layer of adjustable tint material between the second transparent layer and the third transparent layer.

2. The head-mounted device defined in claim 1 further comprising a first transparent conductive electrode on the second transparent layer and a second transparent conductive electrode on the third transparent layer, wherein the first and second transparent conductive electrodes are configured to apply an electric field to the layer of adjustable tint material to control an amount of light transmission associated with the electrically adjustable light modulator.

3. The head-mounted device defined in claim 2 wherein the output coupler comprises a grating on a surface of the first transparent layer facing the air gap.

4. The head-mounted device defined in claim 3 wherein the first transparent layer is configured to guide light associated with the image in accordance with the principal of total internal reflection.

5. The head-mounted device defined in claim 4 further comprising a peripheral ring of adhesive that attaches the third transparent layer to the second transparent layer.

6. The head-mounted device defined in claim 4 wherein the adjustable tint material comprises a guest-host liquid crystal material.

7. The head-mounted device defined in claim 4 wherein the electrically adjustable light modulator comprises an electrically adjustable electrochromic light modulator layer.

8. The head-mounted device defined in claim 4 wherein the first transparent layer comprises a first glass layer and wherein the second transparent layer comprises a second glass layer.

9. The head-mounted device defined in claim 8 wherein the third transparent layer comprises a third glass layer.

10. The head-mounted device defined in claim 9 further comprising first and second lens elements, wherein the waveguide and the electrically adjustable light modulator are between the first and second lens elements.

11. The head-mounted device defined in claim 4 wherein the first transparent layer comprises a first polymer layer and wherein the second transparent layer comprises a second polymer layer.

12. The head-mounted device defined in claim 11 wherein the third transparent layer comprises a third polymer layer.

13. The head-mounted device defined in claim 12 further comprising first and second lens elements, wherein the waveguide and the electrically adjustable light modulator are between the first and second lens elements.

14. The head-mounted device defined in claim 2 wherein the output coupler comprises a hologram.

15. The head-mounted device defined in claim 14 wherein the waveguide comprises a fourth transparent layer and comprises a polymer layer that contains the hologram, wherein the polymer layer is between the first transparent layer and the fourth transparent layer.

16. The head-mounted device defined in claim 1 wherein the third transparent layer is a polymer lens element with a positive lens power.

17. The head-mounted device defined in claim 1 further comprising a first lens element, wherein the third transparent layer comprises a second lens element and wherein the waveguide is between the first lens element and the second lens element.

18. The head-mounted device defined in claim 1 wherein the electrically adjustable light modulator is configured to exhibit a maximum light transmission value of at least 90%.

19. The head-mounted device defined in claim 18 wherein the electrically adjustable light modulator is configured to exhibit a minimum light transmission value of less than 25%. 20 The head-mounted device defined in claim 1 wherein the third transparent layer has first and second opposing curved surfaces.

21. An optical system for a head-mounted device having a projector that produces an image, the optical system comprising:
an inner lens element facing an eye box;
an outer lens element;
a waveguide that is between the inner lens element and the outer lens element, the waveguide having an output coupler that directs the image towards the eye box through the inner lens element; and
an electrically adjustable light modulator having an adjustable tint layer that is between the waveguide and the outer lens element, wherein the waveguide has a main portion and has a cover layer that is attached to the main portion and is separated from the main portion by an air gap and wherein the electrically adjustable light modulator has a transparent conductive coating on the cover layer.

22. The optical system defined in claim 21 wherein the cover layer comprises a cover glass layer, wherein the electrically adjustable light modulator has a glass substrate layer with an additional transparent conductive coating, wherein the adjustable tint layer is between the transparent conductive coating on the cover glass layer and the additional transparent conductive coating on the glass substrate layer, and wherein the glass substrate layer is between the outer lens element and the waveguide.

23. A head-mounted device optical system operable in a head-mounted device with a projector that produces an image, comprising:
a first lens element;
a second lens element;
a waveguide that is between the first and second lens elements and that is configured to guide the image, wherein the waveguide has a waveguide glass layer with a surface relief grating and has a cover glass layer configured to protect the surface relief grating, wherein the cover glass layer is attached to the waveguide glass layer with adhesive so that the surface relief grating is separated by an air gap from the cover glass layer; and
an adjustable light modulator having a transparent conductive electrode on the cover glass layer.
